(19) United States
(12) Patent Application Publication
(10) Pub. No.: US 2004/0059069 A1
(43) Pub. Date: Mar. 25, 2004

(54) Reactive hotmelt adhesive composition for insulating glass

(76) Inventors: Sefan Grimm, Schwetzingen (DE); Manfred Proebster, Nussloch (DE)

Correspondence Address: Stephen D. Harper, Henkel Corporation, Law Department, 2500 Renaissance Blvd., Suite 200, Gulph Mills, PA, 19406, US

(21) Appl. No.: 10/671,644

(22) Filed: Sep. 24, 2003

Related U.S. Application Data
(63) Continuation of application No. 09/202,700, filed on Feb. 19, 1999, now abandoned.
Application No. 09/202,700 is a 371 of international application No. PCT/EP97/02995, filed on Jun. 9, 1997.

(30) Foreign Application Priority Data
Jun. 18, 1996 (DE) 196 24 236.3

(51) Int. Cl. C08G 77/00

(52) U.S. Cl. 525/474

(57) ABSTRACT

Holtmelt adhesive compositions based on a mixture of at least one reactive binder and at least one non-reactive binder are useful as one- or two-part adhesives and/or sealants particularly in the production of multiple glazing systems. The reactive binder may be a polyisobutylene, hydrogenated polybutadiene and/or poly-α-olefin which has been functionalized with silane groups. The non-reactive binder may be a butyl rubber, poly-α-olefin, polybutene, styrene block copolymer and/or a diene or homopolymer. The adhesive compositions act as both a spacer and as a matrix for the moisture-absorbing substances employed in multiple glazing applications, forming an elastic bond or seal at the edges of the glass layers.

This invention relates to hotmelt adhesive compositions and to their use, more particularly for the manufacture of double glazing or multiple glazing.

Insulating glass is now widely used in the building industry and, to a large extent, in vehicle manufacture by virtue of its many advantages, including in particular improved thermal and acoustic insulation in relation to single glazing. It is known that multiple glazing systems consist of two or more layers of glass arranged parallel to one another and joined at their edges in such a way that the space between the layers is sealed off from the ambient air so that no moisture is able to penetrate into that space. In addition, the edge bond/seal is designed to withstand all the various mechanical and chemical stresses which arise out of varying climatic conditions. In many cases, the space in question is even filled with dry gases which increase thermal insulation and acoustic insulation in relation to air fillings.

In commercially available multiple glazing units, rigid spacers keep the layers of glass at the required distance apart from one another. In the most common embodiment, the spacer consists of an aluminium or steel hollow section. It is arranged near the edges of the glass layers in such a way that, together with the edges of the glass layer, the spacer forms an outwardly facing channel for accommodating sealants and adhesives. Normally, that side of the spacer which faces the space between the layers of glass has small openings and the hollow interior of the spacer is used to accommodate a drying agent to adsorb moisture and any solvent residues present in the air 25 or gas space between the layers of glass. This prevents moisture from condensing on the inside of the glass layers at low ambient temperatures. In high-quality multiple glazing systems, a sealant with a good barrier effect against water vapor is provided between those surfaces of the spacer which face the glass layers and the glass surface. Formulations based on polyisobutylene and/or butyl rubber are generally used as the sealant. The channel formed by the outwardly directed face of the spacer and the margins of the glass layers is generally filled with a two-component adhesive/ sealant which bonds/seals the multiple glazing unit with sufficient strength. The adhesive/sealant used must show good adhesion to the glass and, in addition, must be sufficiently elastic to withstand the expansion and contraction movements of the glass layers under varying climatic conditions.

Accordingly, the manufacture of high-quality multiple glazing units of the type in question naturally involves a number of complex process steps and is extremely expensive despite a high degree of automation on large assembly lines. As a result, there has been no shortage of attempts in the past to simplify the complex process steps involved in the production of multiple glazing and, in particular, to eliminate the need for pre-profiled spacers.

The so-called “System Biver” consists, for example, of a thermoplastic inner strand of which the polymer component is preferably composed of polyisobutylene or butyl rubber and which contains a molecular sieve for adsorbing moisture. This strand faces the space between the glass layers and is initially extruded onto one layer of glass, after which the second layer of glass is positioned over the first and the two glass layers are then pressed together until they are at the required distance apart. Thereafter the outer margin is sealed by a generally two-component adhesive/sealant. In this arrangement, the inner strand of the thermoplastic polymer performs the function of the spacer and carries the drying agent and, in addition, acts as the main barrier against water vapor. The outer generally two-component adhesive/sealant provides for the mechanical strength of the double glazing system. This system is described in numerous patents/applications, cf. for example DE-C-25 55 381, DE-A-25 55 383, DE-A-25 55 384 and EP-A-176 388.

DE-A-44 07 892 describes a process for the production of double or multiple glazing systems in which the two or more layers of glass arranged parallel to one another are kept at a distance and, at their margins, are surrounded by an extrusion-coated frame which holds the layers of glass apart from one another. According to the document in question, the material used for extrusion coating is a thermoset, thermoplastic or ceramic material. The composition of the injection molding material is not discussed, nor are any details provided as to whether and how the gas or the air in the space(s) between the glass layers can be kept dry.

EP-A- 517 067 describes a deformable strip-like extrudate for sealing and maintaining the distance between two layers of insulating glass. The deformable strip consists of a flow-resistant polymer matrix which, at its center, contains a flat wave-shaped material which extends perpendicularly of the layers of glass and which is in intimate contact with the polymer matrix. This flat wave-shaped material performs the function of the spacer and, at the same time, acts as a water vapor barrier. The volume of the polymer matrix which faces the space between the layers of glass preferably contains a drying agent. A semi-interpenetrating network consisting of a butyl rubber and a lightly crosslinked polyisobutylene is proposed as the polymer matrix. The preformed deformable sealing strip is produced by co-extrusion of the polymer matrices and the flat wave-shaped material. This preformed sealing tape is then placed on one of the layers of glass, the second glass layer is positioned over the first and the two layers of glass are then pressed together. Since no further curing process takes place after application, the marginal zone between the sealing strip and the glass layer has a tendency towards cold flow.

DE-A-38 34 400 describes a double glazing unit which consists of two layers of glasss joined at their edges by a plastic spacer. The spacer consists of two or more different layers of which the inner layer defines the interior space and consists of a cured adhesive which contains a moisture-absorbing substance while the outer layer consists of a cured adhesive which is different from the adhesive forming the inner layer. The inner layer of the adhesive consists of polymers with a relatively high permeability to water vapor and may additionally contain a powder-form drying agent, for example a molecular sieve, while the outer adhesive layer is said to have a lower specific permeability to water vapor than the inner layer. Polyurethanes or silicone rubbers are proposed for the inner layer while a polysulfide-based adhesive is proposed for the outer layer. This system has the advantage over the above-mentioned double glazing systems that both layers of adhesive consist of reactive materials which crosslink after application so that the mechanical cohesion of the layers of glass is better, even under weathering influences. The disadvantage of this process is that two different materials have to be applied in two process steps.

WO 95/13449 describes sealing profiles preformed for this purpose. The sealing profiles consist of a completely or partly crosslinked polyisobutylene copolymer as the polymer matrix and contain an aluminium foil as a water vapor diffusion barrier. The disadvantage of this system is that the spacer system is made up of several different layers which complicates the production process and which is also unfavorable from the point of view of disposal and/or recycling.

EP-A-232 873 describes sealants for the production of spacer-free double glazing systems based on 20 to 80% by weight of epoxidized natural rubber, 5 to 30% by weight of at least one other epoxy compound and an amine or mercaptan containing trialkoxysilyl groups as crosslinking agent and typical additives, such as coupling agents, tackifiers, plasticizers, fillers, drying agents, antiagers and UV filters. Although double glazing systems such as these show excellent resistance to ageing, their main disadvantage is that they can only be produced as two-component systems where the two reactive components can only be mixed immediately before application.

It has now been found that multiple glazing systems can be produced particularly inexpensively by using hotmelt adhesive compositions which contain a mixture of at least one reactive binder and at least one non-reactive binder, at least one reactive binder consisting of silane-functional polyisobutylene and/or silane-functional hydrogenated polybutadiene and/or silane-functional poly-α-olefin and the non-reactive binder(s) being selected from the group consisting of butyl rubbers, poly-α-olefins, polybutenes, rubbers based on styrene block copolymers, rubbers based on statistical diene homopolymers and/or copolymers.

The preferred silane-functional groups of the reactive binder(s) can be represented by formula (1):

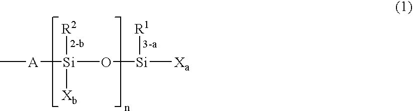

where -A- can represent

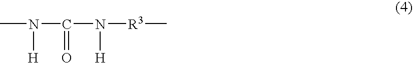

and R¹ and R² may be the same or different and represent an alkyl group containing 1 to 20 carbon atoms, an aryl group containing 6 to 20 carbon atoms or an arylalkyl group containing 7 to 20 carbon atoms, X can be a hydroxyl group or a hydrolyzable group, a can be an integer between 0 and 3 and b can have a value of 0, 1 or 2, the sum of a and b being 1 or greater than 1, and n is a number of 0 to 18, m is an integer of 0 to 4 and R³ represents

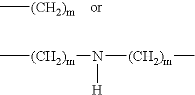

The reactive binder(s) contain(s) at least one silane-functional group corresponding to formula (1). In a preferred embodiment, they contain on a statistical average between 1 and 3 silane-functional groups per molecule. The silane-functional groups are situated either at the ends of the macromolecule (telechelic polymers) or are statistically distributed over the polymer chain. The hydrolyzable group X may be any hydrolyzable group known per se, for example an alkoxy group, acetoxy group, amino group, oxime group or amide group. The hydrolyzable group is preferably an alkoxy group, more preferably a methoxy or ethoxy group.

The silane-functional polyisobutylenes, silane-functional polybutadienes or silane-functional poly-α-olefins are produced in known manner. A telechelic polymer containing olefinically unsaturated terminal groups is normally formed in the first stage and is reacted with organosilicon compounds in a second stage to form silane-functional polyisobutylene, hydrogenated polybutadiene or poly-α-olefin. The various versions of this production process for silane-functional polyisobutylenes or polybutadienes are described, for example, in the following patent applications: EP-A-287 025, EP-A-452 875, EP-A-434 840, EP-A-252 372, EP-A-79 456, EP-A-537 660.

Other possible methods for the production of silane-functional polyisobutylenes or hydrogenated polybutadienes are described in EP-A-312 967. In addition, a hydroxyfunctional polyisobutylene, hydroxyfunctional polybutadiene or hydroxyfunctional poly-α-olefin can be prepared in a first process step and reacted with an isocyanate-functional silane in a second step.

Another possible method for producing the silane-functional binders comprises reacting the nonfunctional polyisobutylenes, hydrogenated polybutadienes or poly-α-olefins with corresponding organofunctional silanes in known manner in a grafting reaction. The silane groups are of course statistically distributed in the polymer chain.

In principle, any rubber-like polymer with no functional groups may be used for the non-reactive binder. However, since the composition as a whole is preferably intended for the production of spacer-free double glazing edge seals/bonds, the non-reactive binder should also be selected from polymers which guarantee low permeability to gases and, in particular, low permeability to water vapor of the glazing unit as a whole. The non-reactive binders may be selected from the group consisting of poly-α-olefins, rubbers based on styrene block copolymers, rubbers based on statistical diene homopolymers and/or copolymers and, in particular, polybutenes or butyl rubbers.

Suitable poly-α-olefins are, for example, ethylene/propylene elastomers, such as ethylene/propylene copolymers and terpolymers of ethylene and propylene with an unconjugated diene (EPDM). Propene/butene copolymers and ethylene/vinyl acetate are also suitable.

The rubbers based on styrene block copolymers are the diblock and triblock copolymers of styrene with a diene, for example butadiene or isoprene, which are commercially available, for example, under the name of Kraton from Shell. Hydrogenated or partly hydrogenated block copolymers may also be used.

Examples of the statistical diene homopolymers and copolymers are polybutadiene, polyisoprene, copolymers thereof and styrene/butadiene copolymers, acrylonitrile/butadiene copolymers and the partly hydrogenated or completely hydrogenated diene polymers of the last-mentioned group.

Natural rubber, more particularly epoxidized natural rubber, may also be used as a non-reactive binder.

By virtue of their particularly favorable barrier effect against water vapor and gases, polybutenes and/or polyisobutene, polyolefins produced by stereospecific polymerization of 1-butene or isobutene and butyl rubbers, i.e. copolymers of isobutylene with isoprene, are most particularly preferred.

The hotmelt adhesive compositions according to the invention may also contain plasticizers, although the plasticizers should be chosen with particular care according to the following criteria:

An extremely low percentage content of volatile components in order to avoid so-called fogging over the life of the double glazing unit. Fogging is a well-known phenomenon whereby small quantities of volatile components of the binder system first enter the space between the layers of glass and condense on the colder parts thereof.

The barrier effect of the polymer matrix against water vapor and gases should not be adversely affected by the plasticizer.

Examples of suitable plasticizers are the phthalate plasticizers known per se based on phthalic acid alkyl or aryl esters, providing their volatile components are so small in number that the plasticizers do not cause any fogging and, in addition, the phthalate plasticizers are compatible with the binder system, i.e. have no tendency towards exudation.

Liquid polybutenes and polyisobutenes are most particularly preferred plasticizers.

The hotmelt adhesive compositions according to the invention may additionally contain components known per se, including in particular water-binding fillers, preferably the zeolites of the 3 A type known as molecular sieves in powder form. In addition, fine-particle inert fillers, for example ground or precipitated chalks, kaolins, clays and carbon blacks may be used. The chalks, kaolins or clays may be used both in their surface-hydrophobicized form or even without any surface pretreatment.

In addition, the compositions contain organofunctional silanes as coupling agents and/or crosslinking agents, including for example 3-glycidyloxypropyl trialkoxysilane, 3-acryloxypropyl trialkoxysilane, 3-aminopropyl trialkoxysilane, vinyl trialkoxysilane, N-aminoethyl-3-aminopropyl methyl dialkoxysilane, phenylaminopropyl trialkoxysilane, aminoalkyl trialkoxydisilane or i-butyl methoxysilane. A particularly preferred alkoxy group is the methoxy or ethoxy group.

Suitable catalysts are any known compounds which are capable of catalyzing the hydrolysis of the hydrolyzable groups of the silane groups and the subsequent condensation of the Si-OH group to siloxane groups (crosslinking reaction or coupling function). Organic compounds of divalent and tetravalent tin are most particularly preferred.

The choice of the antiager used, if any, is governed by the composition of the binder. Antioxidants of the sterically hindered phenol, thioether or high molecular weight mercapto compound type and UV stabilizers of the known benzotriazole, benzophenone or HALS (hindered amine light stabilizer) type may be used. It can be of advantage to add known anti-ozonants. In exceptional cases, hydrolysis stabilizers may also have to be added.

Where the hotmelt adhesive compositions according to the invention are used for the production of multiple glazing units, the multiple glazing unit thus produced is distinguished by the following features in relation to the prior art:

the adhesive mixture acts both as a spacer and as a matrix for the moisture-absorbing substance,

it also forms an elastic bond/seal at the edges of the glass layers,

the water harmful to the useful life of the double glazing unit is not only bound in the matrix by the molecular sieve, it is also at least partly consumed by a chemical reaction in the curing process. A particular advantage is that all the process steps hitherto involved in the formation of a conventional edge seal/bond are now combined into a single step. Another advantage is that, because it consists of only one material, a system of the type in question can be recycled after dismantling of the double glazing unit at the end of its useful life because, in contrast to the prior art, it is not a composite material of polymer matrices differing in their composition.

The compositions according to the invention preferably consist of

| | | | |
|---|---|---|---|
| (a) | silane-functional polyisobutylene, | 20-70% | by weight |
| | silane-functional hydrogenated polybutadiene | | |
| | or silane-functional poly-α-olefin | | |
| (b) | butyl rubber | 5-30% | by weight |
| (c) | poly-α-olefin | 5-30% | by weight |
| (d) | molecular sieve of the zeolite 3A type | 20-30% | by weight |
| (e) | carbon black | 5-30% | by weight |
| (f) | catalyst | 0.1-2% | by weight |
| (g) | organosilane | 0.1-2% | by weight |

The compositions may be produced in known manner by high-shear mixing of the components to homogeneity, optionally in vacuo or in an inert gas atmosphere. The components being mixed may have to be heated or cooled. Since the hotmelt adhesive compositions react with moisture by crosslinking, the compositions have to be protected against moisture pending their final application by the user in order to guarantee adequate stability in storage.

In the embodiment as a one-component adhesive/sealant, all the above-mentioned components are mixed together in the production process. In the two-component embodiment, the catalyst(s) (f) are separately prepared in a paste of the non-reactive binder (b) and/or (c) and part of the filler (e) and optionally plasticizer as component B. The other constituents are prepared as component A, both components being mixed immediately before application. In another embodiment, component A consists of constituents (a) to (g) while component B consists of a water-containing paste, the water optionally being present in this paste in the form of water-releasing compounds, for example salts containing water of crystallization. One advantage of this procedure is that it enables the compositions to be formulated in such a way that a particularly rapid crosslinking reaction takes place, so that a double glazing seal/bond thus formed is capable of withstanding severe mechanical stressing after a particularly short time.

To produce the double glazing units, the layers of glass to be joined are either kept at the predetermined distance apart in known manner and the compositions are injected into the space between the layers at their margins by means of an extruder-like applicator, optionally with heating and profiling. By virtue of the hotmelt-like consistency of the composition, the edge seal/bond develops an early strength after cooling of the adhesive composition sufficient to enable the double glazing units to be immediately further processed, transported or stored. Ultimate strength is developed through the crosslinking of the silane groups of the reactive binder in combination with the organosilane added by reaction with the moisture in the space between the glass layers and/or the ambient air.

In another embodiment, the hotmelt adhesive is applied to the peripheral edge of one layer of glass, optionally with heating and profiling, the second layer of glass or additional layers of glass are then positioned over the first in such a way that the layers of glass are exactly aligned one above the other. They are then pressed together in such a way that the adhesive completely wets the edges of both or all the layers of glass and the predetermined inter-layer spacing is reached. In this embodiment, too, the early strength of the edge seal/bond is developed during the cooling process whereas ultimate strength is achieved by crosslinking with moisture.

As mentioned above, the two components of the two-component hotmelt adhesives are mixed immediately before the application steps just described. The edge seal/bond develops its ultimate strength more quickly in this embodiment than in the one-component version.

1. A hotmelt adhesive composition containing a mixture of at least one reactive binder and at least one non-reactive binder, characterized in that at least one reactive binder consists of silane-functional polyisobutylenes and/or silane-functional hydrogenated polybutadienes and/or silane-functional poly-α-olefins and the non-reactive binder(s) is selected from the group consisting of butyl rubbers, poly-α-olefins, polybutenes, rubbers based on styrene block copolymers, rubbers based on statistical diene homopolymers and/or copolymers.

2. A composition as claimed in claim 1, characterized in that the silane-functional groups of the reactive binder(s) are represented by formula (1): 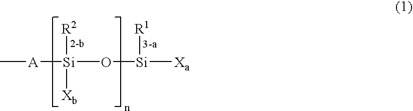
where -A- can represent 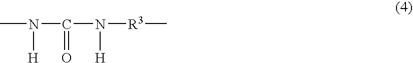
and R¹ and R² may be the same or different and represent an alkyl group containing 1 to 20 carbon atoms, an aryl group containing 6 to 20 carbon atoms or an arylalkyl group containing 7 to 20 carbon atoms, X can be a hydroxyl group or a hydrolyzable group, a =0, 1, 2 or 3 and b =0, 1 or 2, the sum of a and b being 1 or greater than 1, and n is an integer of 0 to 18, m is an integer of 0 to 4 and R³ represents

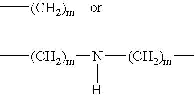

3. A composition as claimed in at least one of the preceding claims, characterized in that it contains
(a) 20 to 70% by weight of silane-functional binder,
(b) 5 to 30% by weight of non-reactive binder,
(c) 20 to 30% by weight of water-binding fillers, preferably molecular sieves of the 3A type,
(d) 5 to 30% by weight of fine-particle inert fillers selected from the group consisting of ground or precipitated chalks, kaolins, clays, carbon blacks,
(e) 0.1 to 2% by weight of organofunctional silanes,
(f) 0.1 to 2% by weight of catalysts,
(g) 0 to 3% by weight of antiagers selected from the group consisting of antioxidants, UV stabilizers, anti-ozonats, hydrolysis stabilizers.

4. A composition as claimed in claim 3, characterized in that it contains 2 to 40% by weight of plasticizer.

5. A two-component composition as claimed in claim 3 or 4, characterized in that one component contains constituents (a) to (e) and (g) and the second component consists of constituents (b), (c), (d), (f) and optionally plasticizer.

6. A two-component composition as claimed in claim 3 or 4, characterized in that one component contains constituents (a) to (g) and the second component consists of a water-containing paste which contains water in dissolved, adsorbed or emulsified form or in the form of solid water-releasing substances and optionally a non-reactive binder (b) and/or plasticizer.

7. A process for producing the compositions claimed in at least one of the preceding claims, characterized in that the constituents are subjected to high-shear mixing to homogeneity, optionally in vacuo or in a dry inert gas atmosphere.

8. The use of the compositions claimed in at least one of the preceding claims as a one-component or two-component adhesive for the production of double glazing or multiple glazing.

9. Double or multiple glazing, characterized in that the compositions claimed in at least one of the preceding claims serve simultaneously as
spacers between the individual layers of glass,
a matrix for the moisture-absorbing substances,
a water vapor barrier and
an elastic edge seal/bond for the glazing.

10. A process for the production of double glazing as claimed in claim 9, characterized by the following process steps:
(a) the layers of glass to be joined are held at the predetermined distance apart,
(b) the compositions claimed in at least one of claims 1 to 4 are injected between the glass layers at their edges, optionally with heating and profiling,
(c) the composition cures to form an elastic seal/bond by absorbing moisture from the space between the layers of glass and/or the ambient air.

11. A process as claimed in claim 9, characterized in that the components of the compositions claimed in claim 5 or 6 are mixed immediately before step (b) is carried out.

12. A process for the production of double glazing as claimed in claim 9, characterized by the following process steps:
(a) the compositions claimed in at least one of claims 1 to 4 are applied to the edge of one layer of glass, optionally with heating and profiling,
(b) the second layer of glass or additional layers of glass is/are positioned over the first in such a way that the layers of are in exact alignment one above the other,
(c) the layers of glass are pressed together in such a way that the adhesive completely wets the edges of both or all layers of glass and the predetermined distance between the layers is reached,
(d) the adhesive composition occurs to form an elastic seal/bond by absorbing moisture from the space between the layers of glass and/or the ambient air.

13. A process as claimed in claim 12, characterized in that the components of the compositions claimed in claim 5 or 6 are mixed immediately before step (a) is carried out.
